(19) United States
(12) Patent Application Publication
(10) Pub. No.: US 2020/0049866 A1
(43) Pub. Date: Feb. 13, 2020

(54) OPTICAL FILM AND BACKLIGHT MODULE USING SAME

(71) Applicants: Chien-Chin Mai, Kaohsiung City (TW); BETA OPTRONIC CO., LTD., Kaohsiung City (TW)

(72) Inventor: Chien-Chin Mai, Kaohsiung City (TW)

(21) Appl. No.: 16/102,721

(22) Filed: Aug. 13, 2018

(51) Int. Cl. G02B 5/04; G02B 5/02; F21V 8/00; G02F 1/1335

(52) U.S. Cl. CPC G02B 5/045; G02B 5/0215; G02B 5/0226; G02F 2001/133607; G02B 5/0278; G02F 1/133606; G02B 6/0053

(57) ABSTRACT

An optical film includes a light incidence surface and a light exit surface. The light incidence surface is provided thereon with a plurality of microstructure lenses, which are each of an irregular shape showing a curved or arc configuration raised on and projecting from the light incidence surface of the optical film. The light exit surface is provided with a plurality of prism microstructures. When light gets incident onto the microstructure lenses formed on the light incidence surface of the optical film according to the present invention, the microstructure lenses scatters the light incident thereon to get into the optical film. The light exits through the light exit surface and is condensed by the microstructure lenses arranged on the light exit surface, so as to achieve uniform diffusion of light and enhanced brightness.

### TECHNICAL FIELD OF THE INVENTION

The present invention relates generally to an optical film and a backlight module using the optical film, and more particularly to a composite optical film that provides dual effects of uniformly spreading light and condensing light and a backlight module using the optical film for improving performance of the backlight module in respect to homogeneity and bettered brightness.

### DESCRIPTION OF THE PRIOR ART

In displaying an image, a liquid crystal display relies on a backlight module to supply light thereto.

As shown in FIG. 1, a conventional backlight module 1 comprises a light source 11, a reflector plate 12, a light guide plate 13, a lower diffuser plate 14, a lower prism sheet 15, an upper prism sheet 16, and an upper diffuser plate 17, wherein the light source 11 is arranged to correspond to and face a light incidence surface 131 formed on a lateral side of the light guide plate 13 such that light emitting from the light source 11 transmit through the light incidence surface 131 to get into the light guide plate 13. A part of the light leaks through a reflection surface 132 of the light guide plate 13. The part of the light that leaks through the reflection surface 132 of the light guide plate 13 is reflected by the reflector plate 12 back into the light guide plate 13 again for re-use. Further, the reflection surface 132 of the light guide plate 13 is provided with a grid dot pattern, which reflects and change a travel path of light incident thereon so that the light is guided to travel toward and exit through a light exit surface 133 of the light guide plate 13. The light exiting the light guide plate 13 passes through the lower diffuser plate 14 for diffusion and homogeneity and is subsequently subjected to light condensation by means of the lower prism sheet 15. The light, after condensation caused by the lower prism sheet 15, passes through the upper prism sheet 16 for converging or condensing in a different direction so that light condensation or convergence is achieved in all directions. The light then transmits through the upper diffuser plate 17 to achieve optimum or best homogeneity through further diffusion, and then the light leaves the backlight module 1 for being supplied to the liquid crystal display for use thereby.

Further referring to FIGS. 2 and 3, in the backlight module 1 described above, the lower diffuser plate 14 and the upper diffuser plate 17 each have a light incidence surface 141, 171 and a light exit surface 142, 172 to which a large number of diffusion particles 18 are adhesively attached, so that light may be scattered or diffused by the diffusion particles 18 to achieve the purpose of uniform diffusion. The lower prism sheet 15 and the upper prism sheet 16 each have a light exit surface 151, 161 on which a number of prism microstructures 1511, 1611 are formed so that light may be refracted by the prism microstructures 1511, 1611 to achieve the purpose of light condensation.

However, the above-descried structure of the conventional backlight module 1 must include the lower diffuser plate 14, the lower prism sheet 15, the upper prism sheet 16, and the upper diffuser plate 17. This makes the cost extremely high. In addition, the diffusion particles 18 that are adhesively attached to the light incidence surfaces 141, 171 and the light exit surfaces 142, 172 of the lower diffuser plate 14 and the upper diffuser plate 17 may get undesirably detached therefrom due to abrasive contact with the light guide plate 13, the lower prism sheet 15, and the upper prism sheet 16. With the diffusion particles 18 so detached, the optical performance of the lower diffuser plate 14 and the upper diffuser plate 17 get deteriorating. Further, the diffusion particles 18 so detached may cause undesired abrasion and wear with respect to the light guide plate 13, the lower prism sheet 15, and the upper prism sheet 16 to cause severe damage, eventually leading to severe deterioration of optical performance of the backlight module 1.

Thus, it is a challenge of the industry to provide a technical solution that helps overcome the drawback of deterioration of diffusion performance of light caused by the diffusion particles 18 of the lower diffuser plate 14 and the upper diffuser plate 17 of the conventional backlight module 1 and also alleviates the issue of abrasion of the light guide plate 13, the lower prism sheet 15, and the upper prism sheet 16 caused thereby.

### SUMMARY OF THE INVENTION

The present invention relates to an optical film and a backlight module using the optical film, which help overcome the drawback of the conventional the optical film that is used for diffusing light with inclusion of diffusion particles suffering deterioration of light diffusion performance resulting from detachment of the diffusion particles and undesired abrasion of other parts used in combination therewith caused by the detached diffusion particles.

To achieve the above objective, the present invention provides an optical film and a backlight module using the optical film. The optical film of the present invention comprises a light incidence surface and a light exit surface, wherein the light incidence surface is provided with a plurality of microstructure lenses arranged thereon with a dense distribution. The microstructure lenses each have an irregular shape showing a curved or arc configuration raised on and projecting from the light incidence surface of the optical film. The microstructure lenses are directly formed on the light incidence surface of the optical film through imprinting or embossing or stamping or the like with a die or a mold so as to make the light incidence surface a roughened surface. Further, the light exit surface is provided thereon with a plurality of prism microstructures.

The efficacy that the present invention may achieve is that when light gets incident onto the microstructure lenses formed on the light incidence surface of the optical film according to the present invention, due to the microstructure lenses of the optical film according to the present invention are made in a curved or arc configuration projecting outward so that the light incident thereon is scattered and diffused to get into the optical film. Further, such microstructure lenses are of irregular shapes so that the effect thereof for scattering and diffusing of light is enhanced to achieve the purpose of homogenous diffusion of light. The light, when subsequently exiting from a light exit surface of the optical film, transmits through microstructure lenses provided on the light exit surface to have the light condensed with such microstructure lenses, whereby an effect that light is first diffused and then condensed may be achieved to provide the result of uniform distribution and diffusion of light and enhanced brightness performance. Further, the microstructure lenses that are provided on the light incidence surface of the optical film according to the present invention are directly formed on the optical film through imprinting or embossing or stamping or the like with a die or mold so that the microstructure lenses and the optical film are integrally formed together as a unitary structure. Thus, there is no concern of detachment of the microstructure lenses and the drawback of the prior art that adhesively attached diffusion particles may get detached to cause undesired consequences.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional backlight module.

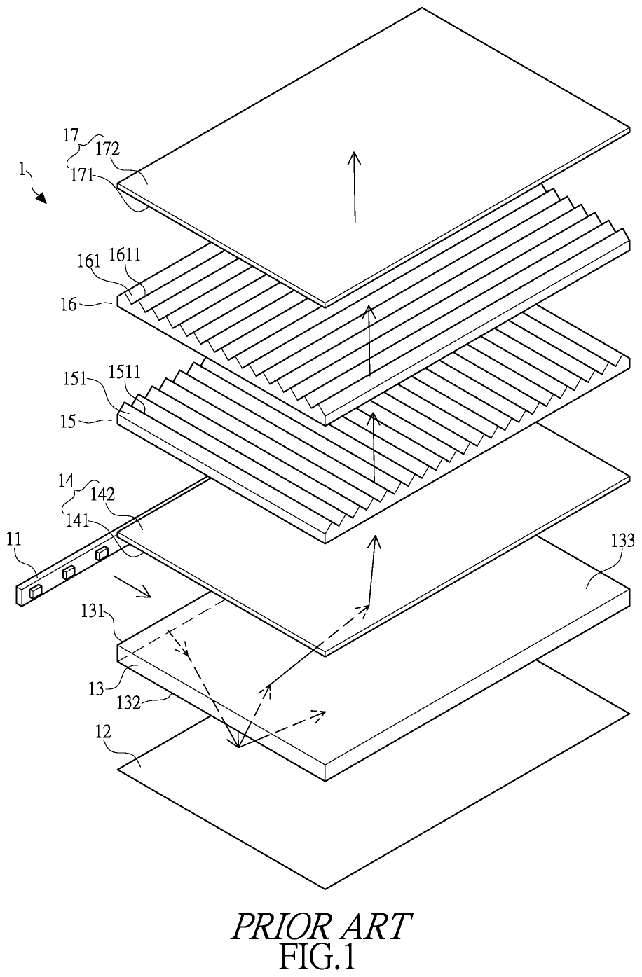

FIG. 2 is a schematic view showing a lower diffusion plate of the conventional backlight module.

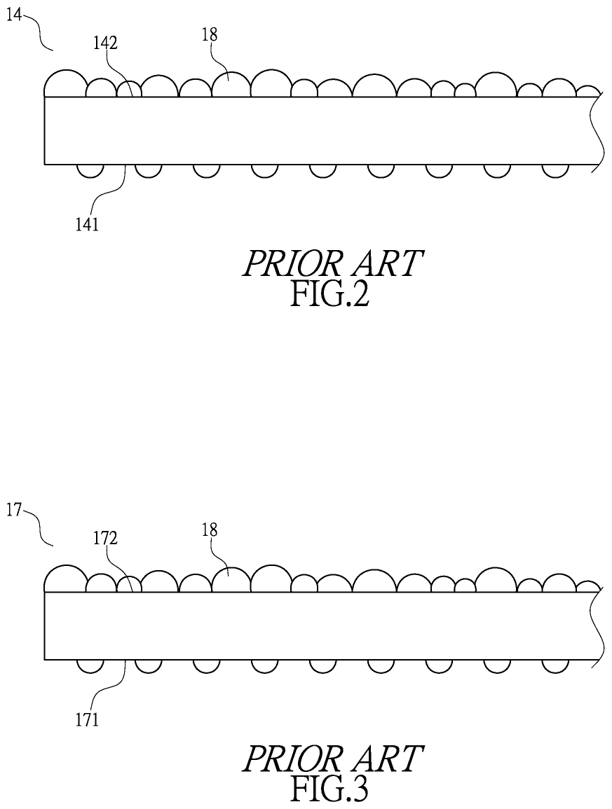

FIG. 3 is a schematic view showing an upper diffusion plate of the conventional backlight module.

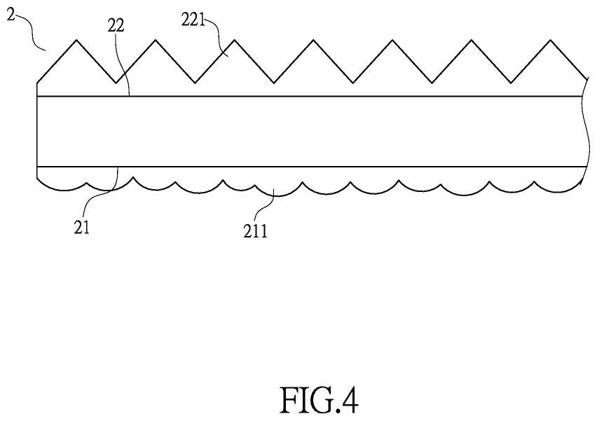

FIG. 4 is a cross-sectional view showing an optical film according to the present invention.

FIG. 5 is a perspective view showing the optical film of the present invention.

FIG. 6 is a schematic view showing another embodiment of the present invention.

FIGS. 7 and 8 are schematic views showing a further embodiment of the present invention.

FIG. 9 is a schematic view showing yet a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

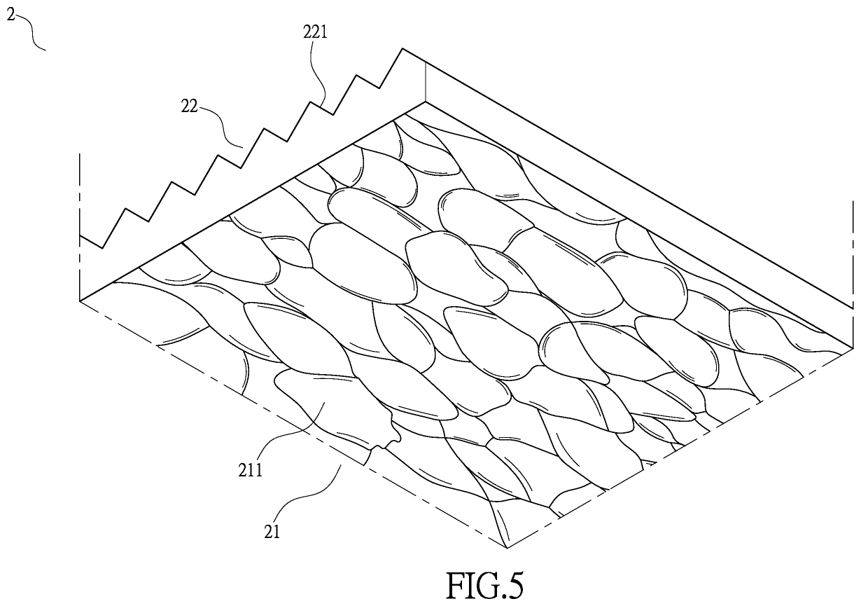

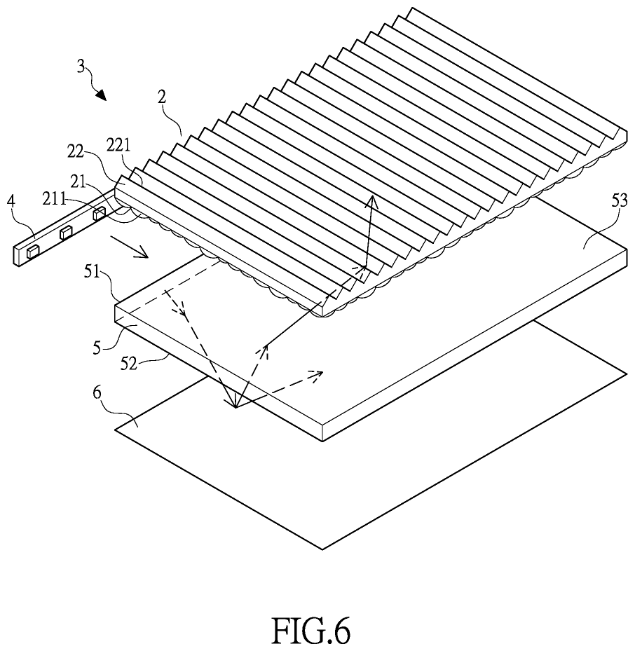

Referring first to FIGS. 4 and 5, the present invention provides an optical film 2. The optical film 2 of the present invention comprises a light incidence surface 21 and a light exit surface 22, wherein the light incidence surface 21 is a surface on which a plurality of microstructure lenses 211 are densely arranged. The microstructure lenses 211 are each formed as an irregular shape or structure, showing a curved or arc configuration projecting outward from and raised on the light incidence surface 21 of the optical film 2. The microstructure lenses 211 are directly formed on the light incidence surface 21 of the optical film 2 through imprinting or embossing or stamping, carried out with a die or mold, so that the light incidence surface 21 is roughened as a rough surface, of which surface roughness (Ra) is preferably 0.1 um-1 um. Further, the light exit surface 22 is provided with a plurality of prism microstructures 221 that are formed or arranged on the surface.

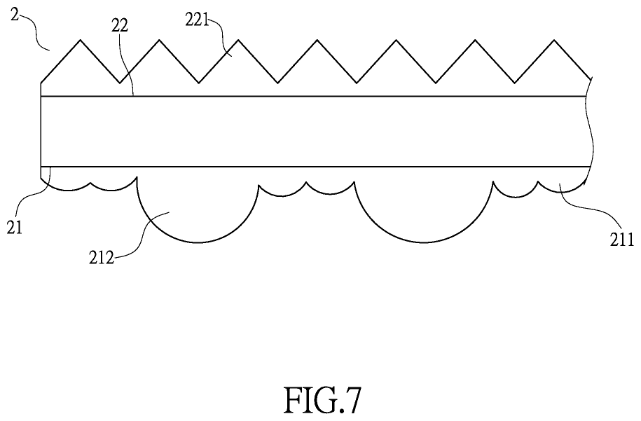

Referring also to FIG. 6, in implementation of the present invention, the optical film 2 of the present invention is provided for use in a backlight module of a liquid crystal display (LCD), wherein the backlight module 3 comprises, at least, a light source 4, a light guide plate 5, and a reflector plate 6. The light source 4 may be a light-emitting diode (LED) based light source. The light guide plate 5 has a light incidence surface 51 that corresponds to and faces the light source 4. The reflector plate 6 is positioned on and in direct contact with a reflection surface 52 of the light guide plate 5. According to the present invention, the optical film 2 is positionable on a light exit surface 53 of the light guide plate 5 such that the light incidence surface 21 of the optical film 2 of the present invention corresponds to and faces the light exit surface 53 of the light guide plate 5 so that the light incidence surface 21 of the optical film 2 of the present invention can receive, immediately, light exiting the light guide plate 5 to have the light passing through the light exit surface 22 of the optical film 2 and projecting outward. Thus, light emitting from the light source 4, after entering the light guide plate 5, is reflected by reflection grid points (not shown) provided on the reflection surface 52 of the light guide plate 5 and the reflector plate 6 to guide the light to exit and project outward from the light exit surface 53 of the light guide plate 5 to subsequently enter the optical film 2 of the present invention, wherein the light gets first incident onto the microstructure lenses 211 formed on the light incidence surface 21 of the optical film 2 of the present invention. The microstructure lenses 211 of the optical film 2 of the present invention are shaped as outward-projecting curved or arc configurations, so that the light incident thereon is scattered and diffused first before entering the optical film 2. This, in combination with the irregular and varying configurations of each of the microstructure lenses 211, would achieve an enhanced effect of scattering and spreading to thereby provide bettered diffusion of light. Particularly, the microstructure lenses 211 that are formed on the light incidence surface 21 of the optical film 2 of the present invention are directly formed on the optical film 2 through imprinting or embossing or stamping with a die or a mold, so that the microstructure lenses 211 are integrally formed with the optical film 2 as a unitary structure. This prevents undesired detachment or separation of the microstructure lenses 211 and helps alleviate the shortcoming of the prior art that diffusion particles that are fixed by means of adhesive could be undesirably detach and thus separate apart. The light, which transmitting through the optical film 2 of the present invention then exits through the light exit surface 22 thereof, and at this moment, the light is caused to transmit through the microstructure lenses 211 of the light exit surface 22, wherein the microstructure lenses 211 provide an effect of condensation of light to condense or converge the light for improving or bettering brightness. In this way, light first undergoes diffusion by means of the microstructure lenses 211 formed on the light incidence surface 21 of the optical film 2 of the present invention and is then subjected to condensation or convergence by means of the prism microstructures 221 provided on the light exit surface 22 of the optical film 2 of the present invention, whereby performance of concentrating or condensing light to provide enhancement of brightness is achieved and light as being so handled with the optical film 2 of the present invention could achieve, at the same time, dual effects of homogeneous diffusion and condensation of light.

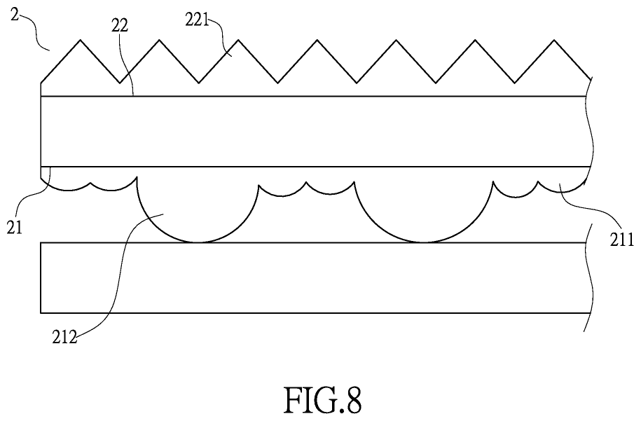

Further, to prevent generation of static electricity when the optical film 2 of the present invention is laid horizontally on the light exit surface 53 of the light guide plate 5, which might lead to the optical film 2 of the present invention being attracted to and attached to the light guide plate 5 to affect optical performance thereof in respect of poor visible phenomenon including bright dots, bright lines, white spots, and hazing. In addition to the plurality of microstructure lenses 211 formed and densely arranged on the light incidence surface 21 of the optical film 2 of the present invention, a plurality of projections 212, which are raised to heights greater than that of the microstructure lenses 211, are provided on and distributed across the light incidence surface 21 of the optical film 2, as shown in FIG. 7. The projections 212 are directly formed on the light incidence surface 21 of the optical film 2 through imprinting or embossing or stamping with a die or mold and the projections 212 are each formed of an irregular body having a curved or arc configuration raised on and projecting from the light incidence surface 21 of the optical film 2. Preferably, the projections 212 are raised to heights that are greater than the heights of the microstructure lenses 211 located adjacent thereto by 1 um, and more preferably being of heights that that are greater than the heights of the microstructure lenses 211 located adjacent thereto by 1 um-10 um. Further, the projections 212 are distributed on the light incidence surface 21 with a number of being not less than 5 in each 1 mm square, so that when the optical film 2 of the present invention is laid flat on the light exit surface 53 of the light guide plate 5, the projections 212 are in contact with and thus abut the light exit surface 53 of the light guide plate 5 to prevent the optical film 2 of the present invention from being excessively close to and closely positioned on the light guide plate 5, allowing the optical film 2 of the present invention and the light guide plate 5 to form a gap therebetween, as shown in FIG. 8, so as to effectively eliminate static electricity between the optical film 2 of the present invention and the light guide plate 5 and prevent the optical film 2 of the present invention from being attracted and attached to the light guide plate 5.

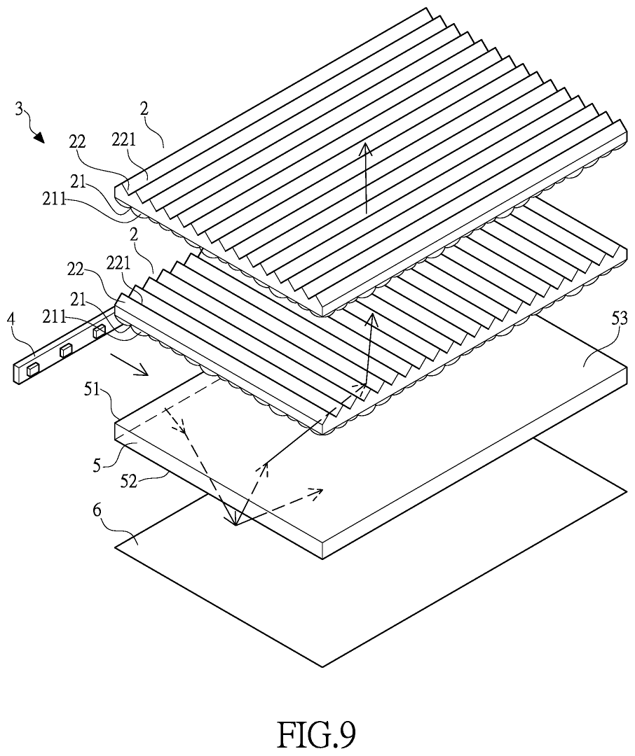

Further referring to FIG. 9, as another embodiment of the present invention, one single a backlight module 3 can be used in combination with two or more than two optical films 2 that are structured according to the present invention. To implement, similarly, a light incidence surface 21 of a lower one of the optical films 2 according to the present invention is arranged to correspond to and face a light exit surface 53 of a light guide plate 5 of the backlight module 3, and a light incidence surface 21 of an upper one of the optical films 2 according to the present invention is arranged to correspond to and face a light exit surface 22 of the first optical film in such a way that prism microstructures 221 formed on the light exit surfaces 22 of the upper and lower optical films 2 are arranged in directions that cross each other so that light may undergo effects of multiple times taking place in different directions with the plurality of optical films 2 according to the present invention to provide an optimum or best result of diffusion and condensation of light.

The efficacy of use of the present invention having the above-described structure is that the optical film 2 according to the present invention is structured such that a light incidence surface 21 thereof is provided with a number of microstructure lenses 211 arranged in a dense distribution, where the microstructure lenses 211 each have an irregular shape taking a curved or arc configuration raised on and projecting from the light incidence surface 21 of the optical film 2 to provide an effect of diffusion to light for achieving a result of homogenizing light. Further, the microstructure lenses 211 are directly formed on the light incidence surface 21 of the optical film 2 through imprinting or embossing or stamping or the like with a die or mold so that the concern that diffusion particles that are used for diffusion of light might suffer detachment or separation of the diffusion particles that leads to reduction of performance and potentially cause risk of damaging other components in contact therewith by the detached particles can be eliminated. Further, the light exit surface 22 of the optical film 2 according to the present invention is provided with a plurality of prism microstructures 221, which help concentrate the light that has been diffused as described above to thereby achieve an effect of condensation of light. Thus, the optical film 2 of the present invention provides dual effects of diffusion of light and condensation of light and it can be used in any desired application with a reduced number thereof so as to effectively lower down the unit price of products and cost of assembly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. An optical film, comprising a light incidence surface and a light exit surface, wherein the light incidence surface is provided with a plurality of microstructure lenses arranged thereon, the microstructure lenses being each of an irregular shape showing a curved or arc configuration raised on and projecting from the light incidence surface of the optical film, so as to make the light incidence surface a roughened surface, the light exit surface being provided thereon with a plurality of prism microstructures,
wherein the plurality of microstructure lenses have irregular sizes and shapes and each of the plurality of microstructure lenses is surrounded by multiple ones of the microstructure lenses such that each of the microstructure lenses has a periphery that is directly connected to the multiple ones of the microstructure lenses.

2. The optical film according to claim 1, wherein the light incidence surface has a roughness value, Ra, which is 0.1 um-1 um.

3. The optical film according to claim 1, wherein the light incidence surface is additionally provided with a plurality of projections distrusted thereon and having heights that are greater than heights of the microstructure lenses.

4. The optical film according to claim 3, wherein the projections are each of an irregular shape showing a curved or arc configuration raised on and projecting from the light incidence surface of the optical film.

5. The optical film according to claim 3, wherein the heights of the projections are greater than the heights of the microstructure lenses located adjacent thereto by at least 1 um.

6. The optical film according to claim 5, wherein the heights of the projections are greater than the heights of the microstructure lenses located adjacent thereto by 1 um-10 um.

7. The optical film according to claim 3, wherein the projections are distributed on the light incidence surface with a number of being not less than 5 in each 1 mm square.

8. A backlight module, comprising:
a light source;
a light guide plate, which comprises a light incidence surface corresponding to and facing the light source;
a reflector plate, which is arranged on a reflection surface of the light guide plate, and
at least one optical film, which is arranged on a light exit surface of the light guide plate, the optical film having a light incidence surface and a light exit surface, wherein the light incidence surface corresponds to and faces the light exit surface of the light guide plate and the light incidence surface is provided with a plurality of microstructure lenses distributed thereon, the microstructure lenses each being of an irregular shape showing a curved and arc configuration raised on and projecting from the light incidence surface, and the light exit surface is provided with a plurality of prism microstructures,
wherein the plurality of microstructure lenses have irregular sizes and shapes and each of the plurality of microstructure lenses is surrounded by multiple ones of the microstructure lenses such that each of the microstructure lenses has a periphery that is directly connected to the multiple ones of the microstructure lenses.

9. The backlight module according to claim 8, wherein the light incidence surface of the optical film is additionally provided with a plurality of projections distrusted thereon and having heights that are greater than heights of the microstructure lenses.

10. The backlight module according to claim 8, wherein the projections are each of an irregular shape showing a curved or arc configuration raised on and projecting from the light incidence surface of the optical film.

11. The backlight module according to claim 8, wherein the heights of the projections are greater than the heights of the microstructure lenses located adjacent thereto by at least 1 um.

12. The backlight module according to claim 11, wherein the heights of the projections are greater than the heights of the microstructure lenses located adjacent thereto by 1 um-10 um.

13. The backlight module according to claim 8, wherein the projections are distributed on the light incidence surface with a number of being not less than 5 in each 1 mm square.

14. The backlight module according to claim 8, wherein the at least one optical film comprises at least two optical films, of which the prism microstructures of the light exit surfaces are arranged in directions that cross each other.
